(19) United States
(12) Patent Application Publication
(10) Pub. No.: US 2004/0249750 A1
(43) Pub. Date: Dec. 9, 2004

(54) Method for electronically issuing and settling bills

(76) Inventor: Hermann Granzer, Pocking (DE)

Correspondence Address: Siemens Corporation, Intellectual Property Department, 170 Wood Avenue South, Iselin, NJ, 08830, US

(21) Appl. No.: 10/491,972

(22) PCT Filed: Oct. 1, 2002
(86) PCT No.: PCT/DE02/03727

(30) Foreign Application Priority Data
Oct. 5, 2001 (DE) 101492987

(51) Int. Cl. G06F 17/60

(52) U.S. Cl. 705/40; 705/39

(57) ABSTRACT

The invention provides the possibility of issuing and settling a bill in a paperless manner in connection with any commercial order (mail-order commerce, other markets) provided that the customer has e-mail access and uses home banking. According to the invention, the bill is issued in the form of an e-mail. Once the customer has established his home banking connection (with the security mechanisms provided to that effect) using a software that is either installed in the PC or is additionally supplied with the e-mail and if the customer so wishes, the bill is then forwarded to his or her bank in order to transfer the billed amount to the issuer of said bill.

### CROSS REFERENCE TO RELATED APPLICATIONS

This application is the US National Stage of International Application No. PCT/DE02/03727, filed Oct. 1, 2002 and claims the benefit thereof. The International Application claims the benefits of German application No. 10149298.7 filed Oct. 5, 2001, both applications are incorporated by reference herein in their entirety.

### FIELD OF INVENTION

The invention relates to a method in accordance with the preamble of claim 1.

The paperless payment of bills is possible using methods such as Paybox (via mobile telephones), credit cards or debit advice. These methods are, however, regarded skeptically by consumers, either because of the technological aspects (Paybox) or because there are reservations regarding security (credit cards).

### BACKGROUND OF INVENTION

Only the issuing of bills has wide acceptance today. Present systems of payment in this case include the issuing of the bill in paper form. To do this, the issuer of the bill prints the bill for the customer on paper and sends it either together with the goods or separately to the customer. The bill is then settled. This is the main method used, because of the acceptance problems already mentioned. The problem in this case is the extra time and cost for the issuer of the bill, including overall administration, printing, postage and the cost of paper.

### SUMMARY OF INVENTION

The object of the invention is to provide a method whereby bills can be efficiently issued and settled and that at the same time finds a high degree of acceptance by the customer.

The object is achieved, based on the preamble of claim 1, by the features given in the characterizing part.

A particular advantage of the invention is that bills that according to the prior art are issued in paper form, are now issued and settled electronically. To do this, for example, an e-mail is provided from the issuer of the bill to the customer. The issuing of the bill by e-mail means on the one hand a large saving in costs for the issuer of the bill (no expense for paper) and on the other hand a lower error rate when filling out the bill form than home banking using special software. Furthermore, the customer does not need to acquire his own home banking program because the information contained in the e-mail provides a direct link to a banking interface (e.g. to the access server of the firm's bank).

For this purpose, the e-mail contains a connection/interface/link (e.g. http URL) to a banking interface. If a customer orders goods, the flow of goods is unaffected by the issuing and settling of the bill. The order is, for example, taken, compiled and dispatched electronically in the direct mail business. The customer thus obtains his goods without a bill and he receives the bill separately by e-mail. He knows that the bill is present by email in the mailbox because he has received the consignment of goods. However, instead of printing out the bill, transferring it to a remittance slip and sending it to his bank, it is possible for the customer to pay the bill directly online.

Advantageous further developments of the invention are given in the subclaims. In principle, methods such as WAP or “Instant Messaging” IM are possible.

The invention is explained in more detail in the following by means of an exemplary embodiment.

### BRIEF DESCRIPTION OF THE DRAWINGS

The illustrations are as follows:

FIG. 1 Issuing of bill by e-mail

FIG. 2 Issuing of bill by billing server

FIG. 3 Issuing of bill by instant messaging

### DETAILED DESCRIPTION OF INVENTION

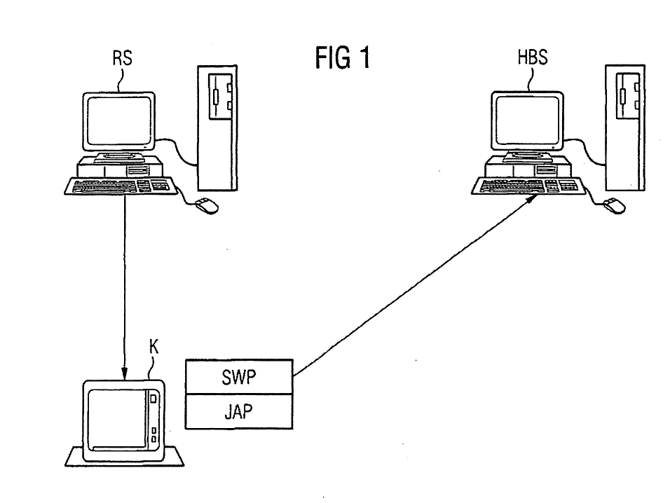

In the example of the embodiment shown in FIG. 1, it is assumed that each customer K has an e-mail connection and can manage his account by means of home banking. This is presently the case for very many households.

In accordance with this exemplary embodiment, the bill is sent by e-mail from the issuer of the bill RS to the relevant customer K. As an option, the e-mail can be encrypted using a cryptographic method such as PGP. The email contains the necessary billing data such as details of the issuer of the bill RS (company designation, account, bank sort code) and the sum to be paid.

The e-mail also contains an instruction, e.g. an http link that accesses the bank access of the customer by means of a home banking interface such as HBCI (Home Banking Computer Interface) or a PIN/TAN and automatically enters the necessary transfer data. The authentication of the transfer by the customer in this case takes place by requesting a PIN or TAN or, in the case of the HBCI interface, by reading the data from the HBCI chipcard.

By clicking on the link contained in the email (e.g. “TRANSFER”) the home banking server HBS is addressed. To do this, a software program SWP loaded on the customer PC can be addressed, that after a simple pre-configuration by the customer constructs the required address of the home banking server HBS and other customer information such as the bank sort code, account number of the customer's bank from the call instruction, in order to transmit the authentication and transfer data. Further data such as the bank sort code and account number of the issuer of the bill RS as well as the amount to be transferred are also taken from the e-mail (or the link). The software program SWP, for example, uses the Internet connection established to read the e-mail, in order to establish contact to the bank by HBCI (or PIN/TAN) and to initiate the transfer. After authentication, the customer can additionally be enabled to prevent the transfer at any time and thus forestall misuse.

Instead of the software program SWP loaded on the customer PC, the necessary software can, for example, be a downloadable application such as Java Applets (JAP) or ActiveX-Controls that is either sent directly in the e-mail or downloaded from a server by clicking the link. Security aspects have an important role to play in this case.

As an alternative, it is provided that the server of the issuer of the bill RS establishes a connection to the banking computer HBS and requests the authentication data from the customer and sends it on in order to initiate the transfer. Although this variant is more expensive than the solution described in the introduction, it is less costly for the customer K and offers greater security due to the correspondingly more secure data links between the issuer of the bill RS and the bank.

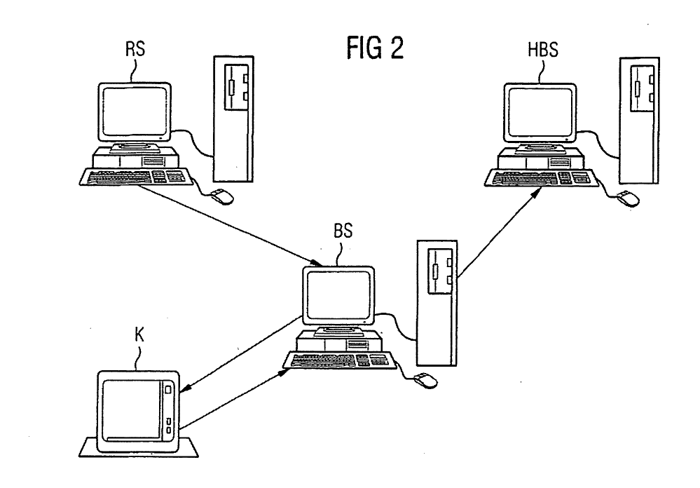

Because the link is given with the e-mail, the insertion of the link is the responsibility of the issuer of the bill RS. FIG. 2 shows how the issuer of the bill RS is relieved of this. To do this, a billing server BS is arranged between the issuer of the bill RS and the customer K.

The billing server BS inserts the necessary link into the e-mail sent by the issuer of the bill and passes this on to the customer K. When he selects a link, the customer then obtains a secure connection to the billing server BS, that passes on the communication to the bank server HBS and also informs the issuer of the bill of the transaction. Further services such as online control of the account status of the customer for the issuer of the bill (i.e. “What bills are still unpaid?”) can be offered by the billing server BS. In the above scenario, the billing server can also make the necessary Java Applet JAP available for download.

Up to now, the issuing of the bill has been described mainly in the context of e-mail as the transfer medium for the bill. The method shown can, however, also be transmitted on WAP or IM messages.

According to this, the customer K receives his bill by SMS and uses WAP to enter the data in the network and can thus pay the bill.

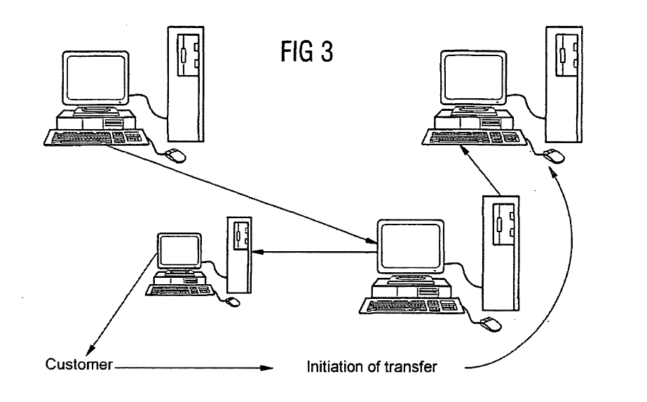

FIG. 3 shows the relevant conditions for instant messages IM.

According to this, the customer K in principle receives a message immediately that a bill is present. The bill data can, as for an e-mail, be issued to the customer, as can also the link described, by means of an instant message IM. This enables the customer, in the same way as for e-mail, to easily and quickly settle the bill. Compared with WAP, this idea has the advantage that no mobile telephone is necessary. In contrast to e-mail, with instant messages IM the customer does not have to act, i.e. call up the e-mail, but instead he receives the bill IM immediately.

Direct home banking access by the customer is not always necessary. By clicking on the e-mail link the customer can also provide a “single direct debit authorization” that applies only to this transaction. Thus, customers that do not have explicit home banking can also use this facility.

1-7. (canceled)

8. A method for electronically issuing and settling bills, comprising:
providing a communication network that exchanges messages between the customer and issuer of the bill;
sending a message to a customer from an issuer of a bill, the message comprising a bill produced by the issuer of the bill and a link;
establishing a connection between the customer and a bank server in accordance with the information contained in programs; and
settling the bill by the bank server.

9. A method in accordance with claim 8, wherein the message sent by the issuer of the bill is in an e-mail.

10. A method in accordance with claim 8, the message sent by the issuer of the bill is a SMS message.

11. A method in accordance with claim 8, the message sent by the issuer of the bill is an instant message.

12. A method in accordance with claim 8, wherein the programs are installed at the customer end as software programs.

13. A method in accordance with claim 8, the programs are formed as Java Applets.

14. A method in accordance with claim 8, wherein the link is inserted into the message in a billing server.

15. A method in accordance with claim 9, wherein the programs are installed at the customer end as software programs.

16. A method in accordance with claim 10, wherein the programs are installed at the customer end as software programs.

17. A method in accordance with claim 11, wherein to programs are installed at the customer end as software programs.

18. A method in accordance with claim 9, the programs are formed as Java Applets.

19. A method in accordance with claim 10, the programs are formed as Java Applets.

20. A method in accordance with claim 11, the programs are formed as Java Applets.

21. A method in accordance with claim 9, wherein the link is inserted into the message in a billing server.

22. A method in accordance with claim 10, wherein the link is inserted into the message in a billing server.

23. A method in accordance with claim 11, wherein the link is inserted into the message in a billing server.

24. A method in accordance with claim 12, wherein the link is inserted into the message in a billing server.

25. A method in accordance with claim 13, wherein the link is inserted into the message in a billing server.
